(19) United States
(12) Patent Application Publication
(10) Pub. No.: US 2007/0158495 A1
(43) Pub. Date: Jul. 12, 2007

(54) High lift and high strength aerofoil

(76) Inventor: Adrian Alexander Hubbard, Wolverhampton (GB)

Correspondence Address: ADRIAN ALEXANDER HUBBARD, 39 EGERTON ROAD, BUSHBURY, WOLVERHAMPTON, WEST MIDLANDS, WV10 8AU, GB

(21) Appl. No.: 11/717,283

(22) Filed: Mar. 14, 2007

(30) Foreign Application Priority Data
Apr. 4, 2003 (GB) GB0307804.5

(51) Int. Cl. B64C 3/14

(52) U.S. Cl. 244/35 R

(57) ABSTRACT

A high lift stepped aerofoil section, incorporating a leading edge 1, trailing edge 3 and a step 2 to provide a higher vertical component in its construction; the aerofoil has greater perceived root thickness giving greater lift through compression 4 on the aerofoil under surface. The section has high pressure area 5 below the aerofoil and low pressure area 6 above the aerofoil. The aerofoil has much higher strength on all axes than conventional aerofoil sections.

### CROSS REFERENCE TO RELATED APPLICATIONS

US Priority Document:—10/780,663

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

Conventional aerofoils have usually quite small thickness compared to their chord and it is difficult to provide adequate strength if they are to be efficient, especially in high speed operation. This invention relates to a high lift aerofoil, incorporating a step, to provide a higher vertical component in its construction. The aerofoil has greater perceived root thickness giving greater lift through compression on the aerofoil under surface, with low pressure on the upper surface, and also giving much higher strength to the aerofoil on all axes compared to conventional aerofoil sections.

### BRIEF SUMMARY OF THE INVENTION

A stepped section aerofoil profile having a chord and a thickness, and comprises a leading edge portion, a trailing edge portion and a central portion. The central portion being between one third and two thirds of the length of the chord of said aerofoil profile. The mean camber line of each of said leading and trailing edge portions being substantially straight and parallel to one another but mutually offset in a direction normal to their mean camber lines to produce a step depth. The central portion being contoured to join the leading and trailing edge portions so as to produce a stepped aerofoil profile. The depth of said step is determined by the application of said stepped aerofoil profile. The stepped aerofoil section is incorporated into a wing or blade having a length substantially perpendicular to the plane of the aerofoil profile, with the step tapering from maximum depth at one end of the length to zero depth at the opposite end of the length.

### BRIEF DESCRIPTION OF THE SEVERAL VEIWS OF THE DRAWING

FIG. 1 illustrates a typical stepped section aerofoil.

FIGS. 2, 2A and 2B illustrate a preferred embodiment of the stepped section, incorporated into a high aspect ratio aircraft wing.

FIGS. 3, 3A and 3B illustrate another preferred embodiment of the stepped section, incorporated into a low aspect ratio aircraft wing.

FIGS. 4, 4A and 4B illustrate another preferred embodiment of the stepped section, incorporated into a delta aircraft wing.

FIGS. 5 and 5A illustrate another preferred embodiment of the stepped section, incorporated into an aircraft propeller blade.

FIGS. 6 and 6A illustrate another preferred embodiment of the stepped section, incorporated into a fan blade.

### DETAILED DESCRIPTION OF THE INVENTION

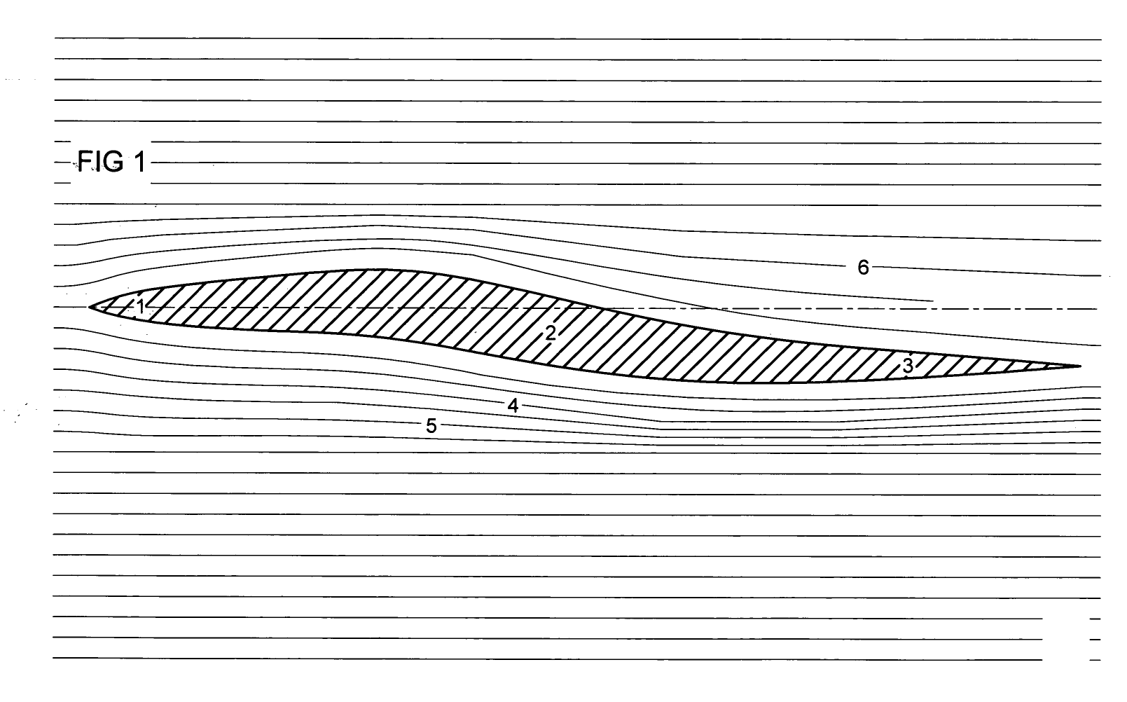

Referring to the drawings the aerofoil has a leading edge 1, a stepped section 2 and a trailing edge 3. The step 2 creates compression 4 on the under surface of the section giving a high pressure area 5 below the aerofoil; above the aerofoil is a low pressure area 6, see FIG. 1.

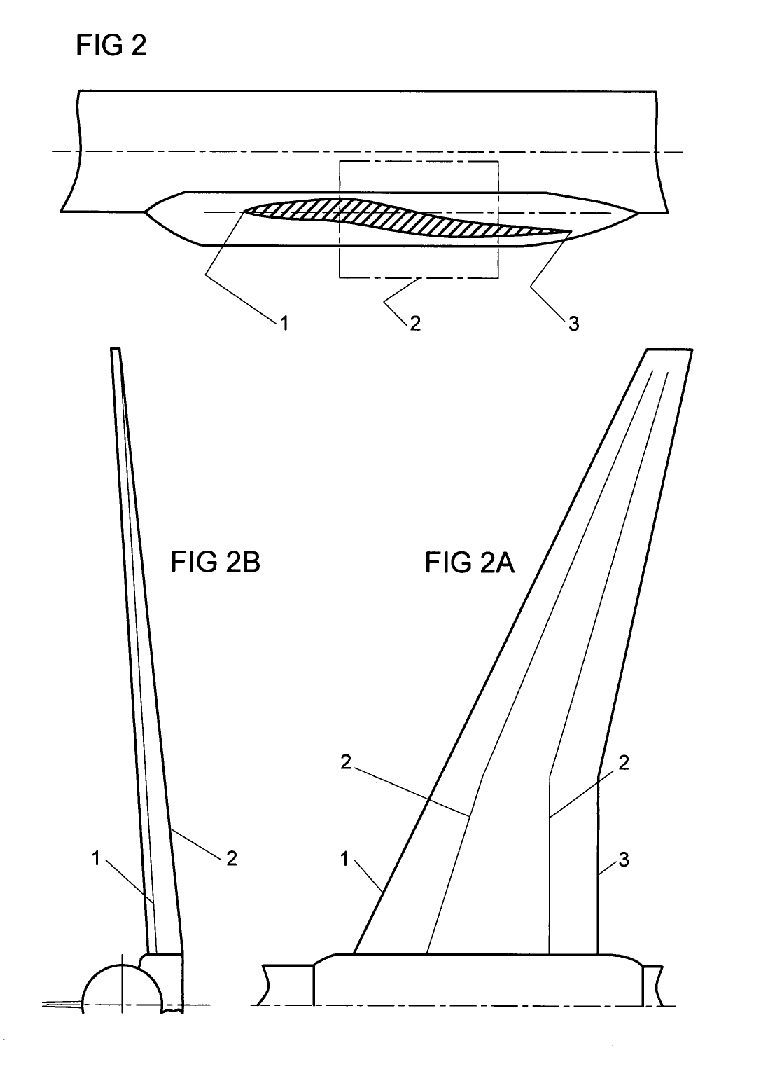

Referring to FIG. 2 the stepped aerofoil is incorporated into a high aspect ratio aircraft wing. The step depth is between half of wing thickness and once wing thickness at the wing root. The step tapers, from maximum depth inboard, to zero depth at the wing tip, see FIGS. 2A and 2B.

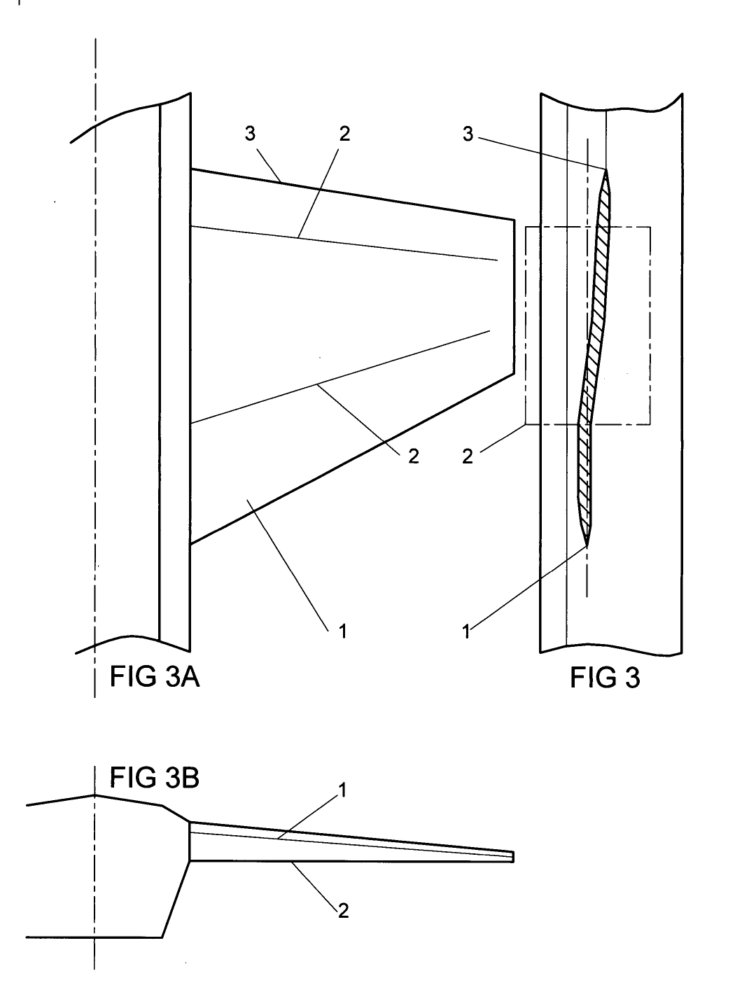

Referring to FIG. 3 the stepped aerofoil is incorporated into a low aspect ratio aircraft wing. The step depth is between once wing thickness and twice wing thickness at the wing root. The step tapers, from maximum depth inboard, to zero depth at the wing tip, see FIGS. 3A and 3B.

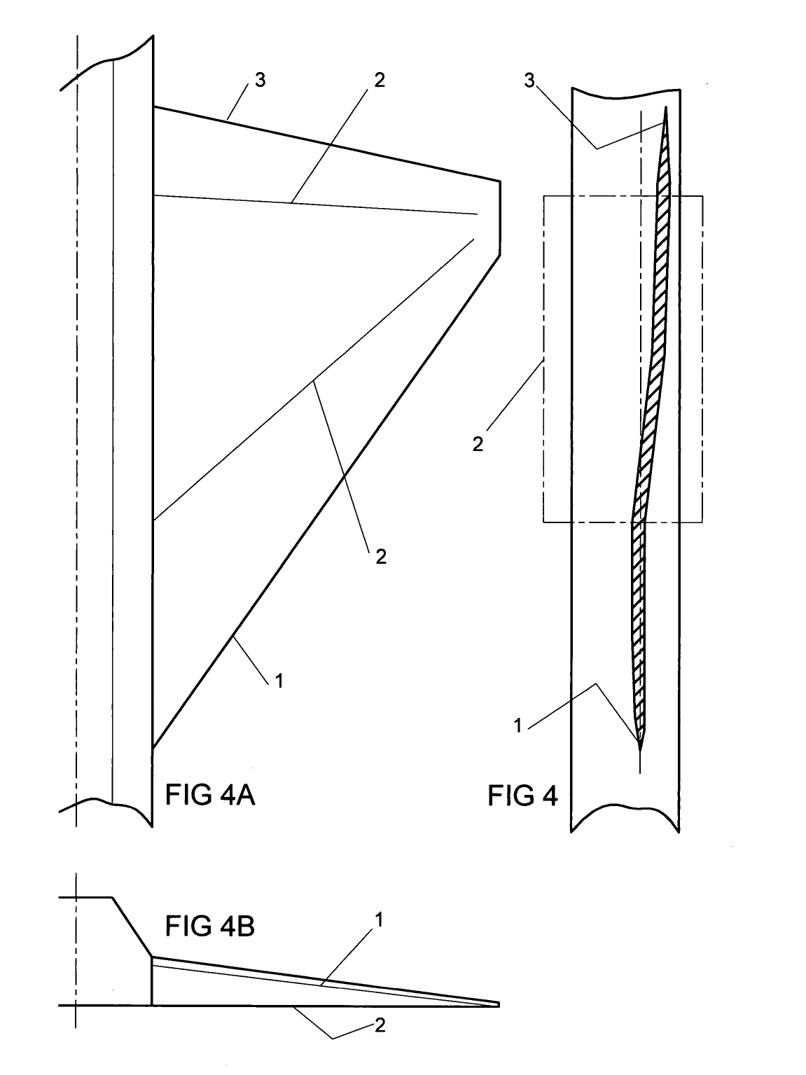

Referring to FIG. 4 the stepped aerofoil is incorporated into a delta aircraft wing. The step depth is between twice wing thickness and three times wing thickness at the wing root. The step tapers, from maximum depth inboard, to zero depth at the wing tip, see FIGS. 4A and 4B.

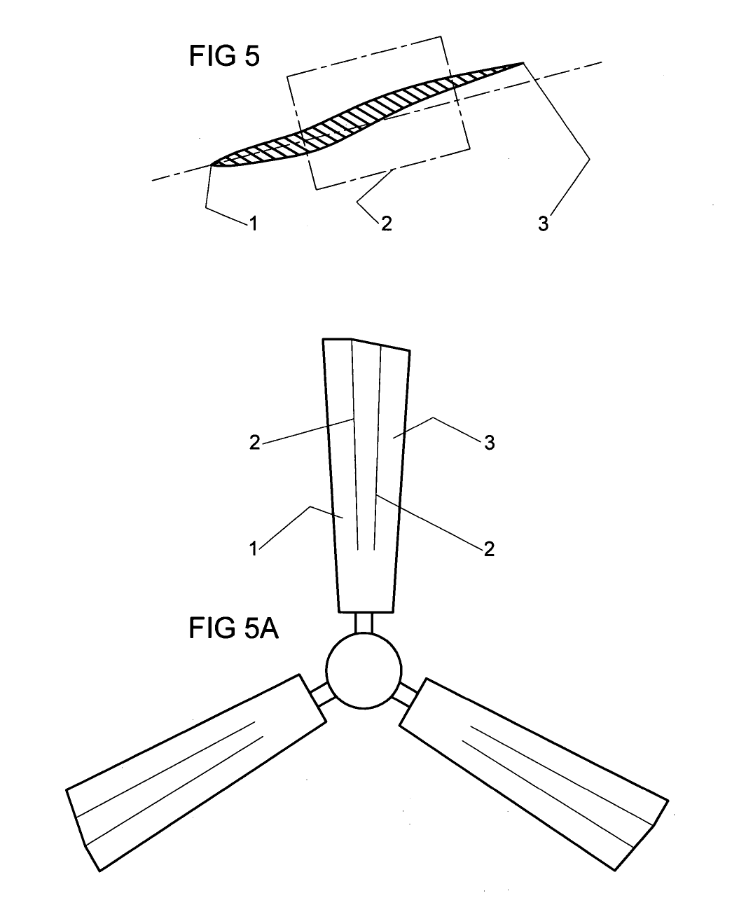

Referring to FIG. 5 the stepped aerofoil is incorporated into an aircraft propeller blade. The step depth is between half of blade thickness and twice blade thickness. The step tapers, from maximum depth outboard, to zero depth at the root, see FIG. 5A.

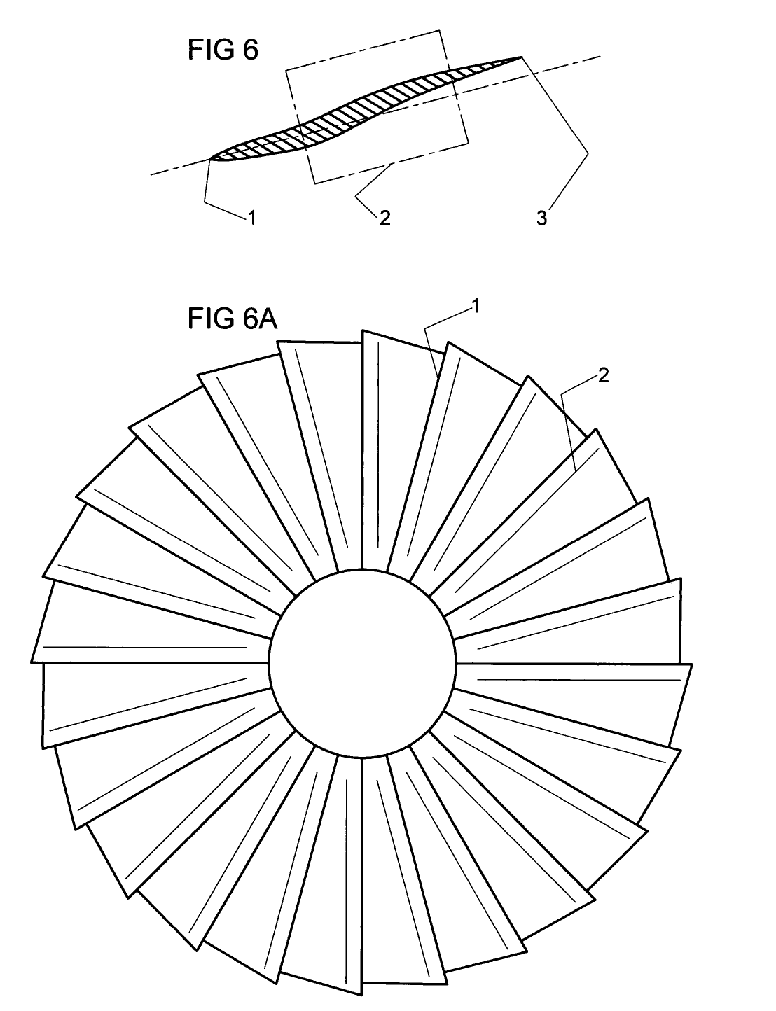

Referring to FIG. 6 the stepped aerofoil is incorporated into a turbofan fan blade. The step depth is between half of blade thickness and twice blade thickness at the blade tip. The step tapers, from maximum depth outboard, to zero depth at the root, see FIG. 6A.

The stepped aerofoil is able to be used for a great many applications which require aerofoils; for lift or downforce, thrust or suction or for turbine blades.

What is claimed is:

1. A stepped section aerofoil profile having a chord and a thickness, and comprises a leading edge portion, a trailing edge portion and a central portion;
said central portion being between one third and two thirds of the length of the chord of said aerofoil profile;
the mean camber line of each of said leading and trailing edge portions being substantially straight and parallel to one another but mutually offset in a direction normal to their mean camber lines to produce a step depth;
said central portion being contoured to join said leading and trailing edge portions so as to produce a stepped aerofoil profile;
the depth of said step is determined by the application of said stepped aerofoil profile;
said stepped aerofoil section is incorporated into a wing or blade having a length substantially perpendicular to the plane of the aerofoil profile, said step tapering from maximum depth at one end of the length to zero depth at the opposite end of the length.

2. An aerofoil as claimed in claim 1 manufactured as a high aspect ratio aircraft wing incorporating said step;
said step depth is between half of said wing thickness and once said wing thickness at said wing root;
said step tapers, from maximum depth inboard of said wing, to zero depth at the tip of said wing.

3. An aerofoil as claimed in claim 1 manufactured as a low aspect ratio aircraft wing incorporating said step;
said step depth is between once said wing thickness and twice said wing thickness at said wing root;
said step tapers, from maximum depth inboard of said wing, to zero depth at the tip of said wing.

4. An aerofoil as claimed in claim 1 manufactured as a delta aircraft wing incorporating said step;
said step depth is between twice said wing thickness and three times said wing thickness at said wing root;
said step tapers, from maximum depth inboard of said wing, to zero depth at the tip of said wing.

5. An aerofoil as claimed in claim 1 manufactured as an aircraft propeller blade incorporating said step;
said step depth is between half of said blade thickness and twice said blade thickness at said blade tip.
said step tapers, from maximum depth at the tip of said blade, to zero depth at the root of said blade.

6. An aerofoil as claimed in claim 1 manufactured as a turbofan fan blade incorporating said step;
said step depth is between half said blade thickness and twice said blade thickness at said blade tip;
said step tapers, from maximum depth at the tip of said blade, to zero depth at the root of said blade.

7. An aerofoil as claimed in claim 1 used for any kind of lift or downforce, thrust or suction or as an impellor.
